(19) United States
(12) Patent Application Publication
(10) Pub. No.: US 2013/0294611 A1
(43) Pub. Date: Nov. 7, 2013

(54) SOURCE SEPARATION BY INDEPENDENT COMPONENT ANALYSIS IN CONJUCTION WITH OPTIMIZATION OF ACOUSTIC ECHO CANCELLATION

(71) Applicants: Jaekwon Yoo, Foster City, CA (US); Ruxin Chen, Redwood City, CA (US)

(72) Inventors: Jaekwon Yoo, Foster City, CA (US); Ruxin Chen, Redwood City, CA (US)

(73) Assignee: Sony Computer Entertainment Inc., Tokyo (JP)

(21) Appl. No.: 13/464,842

(22) Filed: May 4, 2012

(51) Int. Cl. H04B 3/20

(52) U.S. Cl. 381/66

(57) ABSTRACT

Methods and apparatus for signal processing are disclosed. Source separation can be performed to extract source signals from mixtures of source signals and perform acoustic echo cancellation. Independent component analysis may be used to perform the source separation in conjunction with acoustic echo cancellation on the time-frequency domain mixed signals to generate at least one estimated source signal corresponding to at least one of the original source signals. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### CROSS-REFERENCE TO RELATED APPLICATIONS

This application is related to commonly-assigned, co-pending application Ser. No. ______, to Jaekwon Yoo and Ruxin Chen, entitled SOURCE SEPARATION USING INDEPENDENT COMPONENT ANALYSIS WITH MIXED MULTI-VARIATE PROBABILITY DENSITY FUNCTION, (Attorney Docket No. SCEA11030US00), filed the same day as the present application, the entire disclosures of which are incorporated herein by reference. This application is also related to commonly-assigned, co-pending application Ser. No. ______, to Jaekwon Yoo and Ruxin Chen, entitled SOURCE SEPARATION BY INDEPENDENT COMPONENT ANALYSIS IN CONJUNCTION WITH SOURCE DIRECTION INFORMATION, (Attorney Docket No. SCEA11032US00), filed the same day as the present application, the entire disclosures of which are incorporated herein by reference. This application is also related to commonly-assigned, co-pending application Ser. No. ______, to Jaekwon Yoo and Ruxin Chen, entitled SOURCE SEPARATION BY INDEPENDENT COMPONENT ANALYSIS WITH MOVING CONSTRAINT, (Attorney Docket No. SCEA11033US00), filed the same day as the present application, the entire disclosures of which are incorporated herein by reference.

### FIELD OF THE INVENTION

Embodiments of the present invention are directed to signal processing. More specifically, embodiments of the present invention are directed to audio signal processing and source separation methods and apparatus utilizing independent component analysis (ICA) in conjunction with acoustic echo cancellation (AEC).

### BACKGROUND OF THE INVENTION

Source separation has attracted attention in a variety of applications where it may be desirable to extract a set of original source signals from a set of mixed signal observations.

Source separation may find use in a wide variety of signal processing applications, such as audio signal processing, optical signal processing, speech separation, neural imaging, stock market prediction, telecommunication systems, facial recognition, and more. Where knowledge of the mixing process of original signals that produces the mixed signals is not known, the problem has commonly been referred to as blind source separation (BSS). Independent component analysis (ICA) is an approach to the source separation problem that models the mixing process as linear mixtures of original source signals, and applies a de-mixing operation that attempts to reverse the mixing process to produce a set of estimated signals corresponding to the original source signals. Basic ICA assumes linear instantaneous mixtures of non-Gaussian source signals, with the number of mixtures equal to the number of source signals. Because the original source signals are assumed to be independent, ICA estimates the original source signals by using statistical methods extract a set of independent (or at least maximally independent) signals from the mixtures.

While conventional ICA approaches for simplified, instantaneous mixtures in the absence of noise can give very good results, real world source separation applications often need to account for a more complex mixing process created by real world environments. A common example of the source separation problem as it applies to speech separation is demonstrated by the well-known “cocktail party problem,” in which several persons are speaking in a room and an array of microphones is used to detect speech signals from the separate speakers. The goal of ICA would be to extract the individual speech signals of the speakers from the mixed observations detected by the microphones; however, the mixing process may be complicated by a variety of factors, including noises, music, moving sources, room reverberations, echoes, and the like. In this manner, each microphone in the array may detect a unique mixed signal that contains a mixture of the original source signals (i.e. the mixed signal that is detected by each microphone in the array includes a mixture of the separate speakers' speech), but the mixed signals may not be simple instantaneous mixtures of just the sources. Rather, the mixtures can be convolutive mixtures, resulting from room reverberations and echoes (e.g. speech signals bouncing off room walls), and may include any of the complications to the mixing process mentioned above.

Mixed signals to be used for source separation can initially be time domain representations of the mixed observations (e.g. in the cocktail party problem mentioned above, they would be mixed audio signals as functions of time). ICA processes have been developed to perform the source separation on time-domain signals from convolutive mixed signals and can give good results; however, the separation of convolutive mixtures of time domain signals can be very computationally intensive, requiring lots of time and processing resources and thus prohibiting its effective utilization in many common real world ICA applications.

A much more computationally efficient algorithm can be implemented by extracting frequency data from the observed time domain signals. In doing this, the convolutive operation in the time domain is replaced by a more computationally efficient multiplication operation in the frequency domain. A Fourier-related transform, such as a short-time Fourier transform (STFT), can be performed on the time-domain data in order to generate frequency representations of the observed mixed signals and load frequency bins, whereby the STFT converts the time domain signals into the time-frequency domain. A STFT can generate a spectrogram for each time segment analyzed, providing information about the intensity of each frequency bin at each time instant in a given time segment.

Traditional approaches to frequency domain ICA involve performing the independent component analysis at each frequency bin (i.e. independence of the same frequency bin between different signals will be maximized). Unfortunately, this approach inherently suffers from a well-known permutation problem, which can cause estimated frequency bin data of the source signals to be grouped in incorrect sources. As such, when resulting time domain signals are reproduced from the frequency domain signals (such as by an inverse STFT), each estimated time domain signal that is produced from the separation process may contain frequency data from incorrect sources.

Various approaches to solving the misalignment of frequency bins in source separation by frequency domain ICA have been proposed. However, to date none of these approaches achieve high enough performance in real world noisy environments to make them an attractive solution for acoustic source separation applications.

Conventional approaches include performing frequency domain ICA at each frequency bin as described above and applying post-processing that involves correcting the alignment of frequency bins by various methods. However, these approaches can suffer from inaccuracies and poor performance in the correcting step. Additionally, because these processes require an additional processing step after the initial ICA separation, processing time and computing resources required to produce the estimated source signals are greatly increased.

To date, known approaches to frequency domain ICA suffer from one or more of the following drawbacks: inability to accurately align frequency bins with the appropriate source, requirement of a post-processing that requires extra time and processing resources, poor performance (i.e. poor signal to noise ratio), inability to efficiently analyze multi-source speech, requirement of position information for microphones, and a requirement for a limited time frame to be analyzed.

In addition to the permutation problem noted above, additional complications can arise in audio signal processing applications where microphones and loudspeakers are located close enough for the microphones to detect sounds emanating from the loudspeakers. When this happens, an undesirable coupling between the loudspeakers and microphones may occur, causing the loudspeaker signals to interfere with local source signals detected by the microphones. Techniques generally known as acoustic echo cancellation (AEC) techniques are typically used to deal with this problem.

Acoustic echo cancellation has a variety of applications to audio signal processing technologies, including teleconferencing, videoconferencing, video games, mobile phones, hands free car kits, and more. Acoustic echo cancellation has particular applicability to full duplex communication systems, i.e. point to point communication systems that allow communication in both directions simultaneously.

The principles of AEC can best be understood by considering a simple, single channel, two way teleconferencing application between two distant rooms as an example. Each location contains a microphone for detecting local speech signals originating from the local room and a loudspeaker for transmitting speech signals originating from the distant room. In this situation, the distant room is commonly referred to as the “far end,” while the local room is referred to as the “near end.” A problem of undesirable coupling may occur between a loudspeaker and microphone located in the same room, such that the far end loudspeaker signal contains a repeated echo of sound that originally came from the far end, caused by the near end microphone detecting those signals as replayed in the near end loudspeaker. In other words, a person located in a room may hear a repeated echo of his own voice because the microphone in the distant location detects that signal when it is replayed in the distant room.

In order to remove these echoes that interfere with the desired signal, AEC techniques use filters in combination with known reference signals to model the echo signal that needs to be removed. The reference signal is typically the transmission signal that originally creates the echoes, and filters are used to model impulse response of the room in order to model the actual echo interference that is detected in the microphone. Furthermore, the filters generally need to be able to adapt to changing reverberant conditions in the room, such as when a local speaker changes position in the room, altering the impulse response of the room and requiring new models to determine the echo signal that needs to be cancelled. In order to accurately model the impulse response of the room, the AEC filters are generally optimized by an iterative process based on data received on the microphone until they converge to within an acceptable level. Accordingly, when the adaptive filters model the impulse response of the room, echoes can be cancelled from the microphone signal by applying the adaptive filter to the known reference signal and removing this signal from the microphone signal.

Complications arise when acoustic echo cancellation is applied to multichannel signals, such as those received in a microphone array or transmitted from a plurality of speakers, and it is desirable to have techniques that can effectively handle acoustic echoes in multichannel signals while simultaneously extracting source signals from their mixture observations.

Known popular approaches to performing array processing using blind source separation and acoustic echo cancellation involve concatenation of otherwise independent BSS and AEC processes. For example, AEC may be performed first on multi-channel array signal data and the resulting echo-cancelled multi-channel output array data may serve as the input for BSS or vice versa.

It is within this context that a need for the present invention arises.

### BRIEF DESCRIPTION OF THE DRAWINGS

The teachings of the present invention can be readily understood by considering the following detailed description in conjunction with the accompanying drawings, in which:

FIG. 1A is a schematic of a source separation process.

FIG. 1B is a schematic of a mixing and de-mixing model of a source separation process.

FIG. 2 is a flow diagram of an implementation of source separation utilizing ICA according to an embodiment of the present invention.

FIG. 3 is a schematic of combined source separation and acoustic echo cancellation according to an embodiment of the present invention.

FIG. 4A is a drawing demonstrating the difference between a singular probability density function and a mixed probability density function.

FIG. 4B is a spectrogram demonstrating the difference between a singular probability density function and a mixed probability density function.

FIG. 5 is a block diagram of a source separation apparatus according to an embodiment of the present invention.

### DETAILED DESCRIPTION

Embodiments of the present invention combine source separation by independent component analysis with acoustic echo cancellation to solve the source separation and multichannel acoustic echo cancellation problem jointly. Accordingly, embodiments of the present invention can be used to extract source signals from a set of mixed observation signals, wherein the source signals are mixed in an acoustic environment that produces interfering echoes in the mixed observation signals. This joint ICA and AEC solution can produce clean separated audio signals free from echoes.

In embodiments of the present invention, the solutions to the acoustic echo cancellation and source separation operations are jointly obtained by optimization. Joint optimization can produce solutions to independent component analysis de-mixing operations (i.e. ICA de-mixing matrix) and acoustic echo cancellation filter operations (i.e. AEC filters) in the same solution. When convergence of the joint optimization problem is achieve, the solution to the combined signal processing techniques described herein can produce clean estimated signals free from echoes that correspond to original source signals.

Embodiments of the present invention can have applications where desired source signals and interfering signals that create acoustic echoes are mixed in an environment. The signals can be detected by a sensor array, which creates a plurality of different mixtures of the source signals to be used as inputs to the combined source separation and acoustic echo cancellation problem.

In order to address the permutation problem described above, the ICA component of the combined model described herein can define relationships between frequency bins according to multivariate probability density functions. In this manner, the permutation problem can be substantially avoided by accounting for the relationship between frequency bins in the source separation process and thereby preventing misalignment of the frequency bins as described above.

The parameters for each multivariate PDF that appropriately estimates the relationship between frequency bins can depend not only on the source signal to which it corresponds, but also the time frame to be analyzed (i.e. the parameters of a PDF for a given source signal will depend on the time frame of that signal that is analyzed). As such, the parameters of a multivariate PDF that appropriately models the relationship between frequency bins can be considered to be both time dependent and source dependent. However, it is noted that the general form of the multivariate PDF can be the same for the same types of sources, regardless of which source or time segment that corresponds to the multivariate PDF. For example, all sources over all time segments can have multivariate PDFs with super-Gaussian form corresponding to speech signals, but the parameters for each source and time segment can be different.

Embodiments of the present invention can account for the different statistical properties of different sources as well as the same source over different time segments by using weighted mixtures of component multivariate probability density functions having different parameters in the ICA calculation. The parameters of these mixtures of multivariate probability density functions, or mixed multivariate PDFs, can be weighted for different source signals, different time segments, or some combination thereof. In other words, the parameters of the component probability density functions in the mixed multivariate PDFs can correspond to the frequency components of different sources and/or different time segments to be analyzed. Approaches to frequency domain ICA that utilize probability density functions to model the relationship between frequency bins fail to account for these different parameters by modeling a single multivariate PDF in the ICA calculation. Accordingly, embodiments of the present invention that utilize mixed multivariate PDFs are able to analyze a wider time frame with better performance than embodiments that utilize singular multivariate PDFs, and are able account for multiple speakers in the same location at the same time (i.e. multi-source speech).

### ASPECTS OF THE INVENTION

Certain aspects of the present invention differ from known methods of acoustic echo cancellation and independent component analysis even for non-mixed cases. These aspects include the following.

### (1) Use of Multivariate (MV) Probability Density Functions or MV-PDF.

In embodiments of the present invention, AEC and array processing can be optimized in the frame work of independent component analysis in the frequency domain. By using a new multivariate form of PDF, embodiments of the present invention do not suffer from the permutation problem. Embodiments of the present invention are believed to implement the first method of joint optimization of AEC and ICA by using MV-PDF. As a consequence, the formulation of the joint optimization problem and the final optimized solution differs from prior. An example of such a MV-PDF is described by equation (14) below.

### (2) Cost Function in Light of MV-PDF

Embodiments of the present invention are believed to be the first to implement the joint optimization of maximizing the cost function of negentropy. An example of this is described by equation (26) below.

### (3) Additional Constraint Equation (34) or (35) is Used for Finding the Final Solution.

One can apply embodiments of this invention to obtain all local sources in combination of source separation and AEC problem using equation (34). One can also apply embodiments of this invention to obtain a single source in combination of source extraction and AEC problem by using equation (35).

### Source Separation Problem Set Up

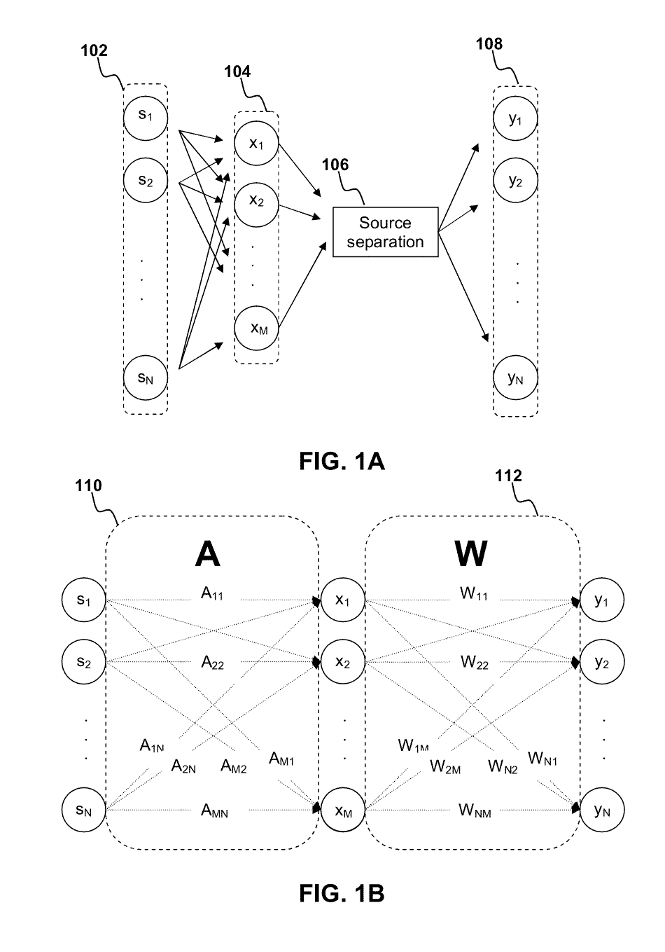

First, basic models of source separation operations will be explained with reference to FIG. 1. Referring to FIG. 1A, a basic schematic of a source separation process having N separate signal sources 102 is depicted. Signals from sources 102 can be represented by the column vector s=[s₁, s₂, . . . , s_{N}]^{T}. It is noted that the superscript T simply indicates that the column vector s is simply the transpose of the row vector [s₁, s₂, . . . , s_{N}]. Note that each source signal can be a function modeled as a continuously random variable (e.g. a speech signal as a function of time), but for now the function variables are omitted for simplicity. The sources 102 are observed by M separate sensors 104 (i.e. a multi-channel sensor having M channels), producing M different mixed signals which can be represented by the vector x=[x₁, x₂, . . . , x_{M}]^{T}. Source separation 106 separates the mixed signals x=[x₁, x₂, . . . , x_{M}]^{T} received from the sensors 104 to produce estimated source signals 108, which can be represented by the vector y=[y₁, y₂, . . . , y_{N}]^{T} and which correspond to the source signals from signal sources 102. Source separation as shown generally in FIG. 1A can produce the estimated source signals y=[y₁, y₂, . . . , y_{N}]^{T} that correspond to the original sources 102 without information of the mixing process that produces the mixed signals observed by the sensors x=[x₁, x₂, . . . , x_{M}]^{T}.

Referring to FIG. 1B, a basic schematic of a general ICA operation to perform source separation as shown in FIG. 1A is depicted. In a basic ICA process, the number of sources 102 is equal to the number of sensors 104, such that M=N and the number observed mixed signals is equal to the number of separate source signals to be reproduced. Before being observed by sensors 104, the source signals s emanating from sources 102 are subjected to unknown mixing 110 in the environment before being observed by the sensors 104. This mixing process 110 can be represented as a linear operation by a mixing matrix A as follows:

$$A = [ \begin{matrix}{A}_{11} & … & {A}_{1 N} \\ ⋮ & ⋱ & ⋮ \\ {A}_{M 1} & … & {A}_{MN}\end{matrix} ] \qquad ( 1 )$$

Multiplying the mixing matrix A by the source signals vector s produces the mixed signals x that are observed by the sensors, such that each mixed signal xᵢ is a linear combination of the components of the source vector s, and:

$$[ \begin{matrix}{x}_{1} \\ ⋮ \\ {x}_{N}\end{matrix} ] = [ \begin{matrix}{A}_{11} & … & {A}_{1 N} \\ ⋮ & ⋱ & ⋮ \\ {A}_{M 1} & … & {A}_{MN}\end{matrix} ] [ \begin{matrix}{s}_{1} \\ ⋮ \\ {s}_{N}\end{matrix} ] \qquad ( 2 )$$

The goal of ICA is to determine a de-mixing matrix W of 112 that is the inverse of the mixing process, such that W=A⁻¹. The de-mixing matrix 112 can be applied to the mixed signals x=[x₁, x₂, . . . , x_{M}]^{T} to produce the estimated sources y=[y₁, y₂, . . . , y_{N}]^{T} up to the permuted and scaled output, such that,

y=Wx=WAs≅=PDs (3)

where P and D represent a permutation matrix and a scaling matrix, respectively, each of which has only diagonal components.

### Flowchart Description

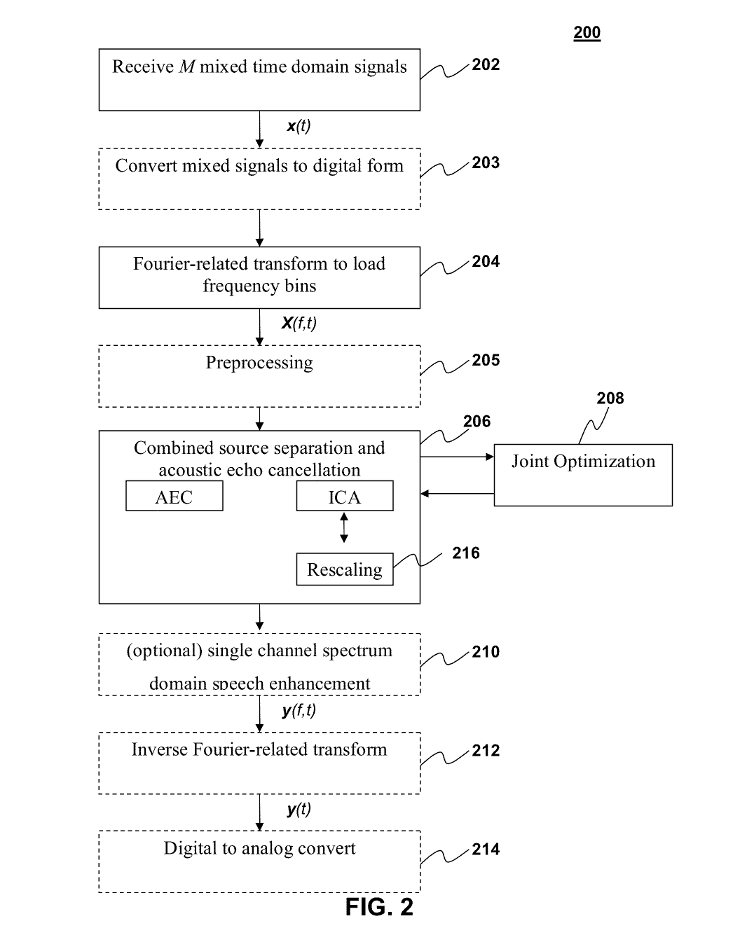

Referring now to FIG. 2, a flowchart of a method of signal processing 200 according to embodiments of the present invention is depicted. Signal processing 200 can include receiving M mixed signals 202. Receiving mixed signals 202 can be accomplished by observing signals of interest with an array of M sensors or transducers such as a microphone array having M microphones that convert observed audio signals into electronic form for processing by a signal processing device. The signal processing device can perform embodiments of the methods described herein and, by way of example, can be an electronic communications device such as a computer, handheld electronic device, videogame console, or electronic processing device. The microphone array can produce mixed signals x₁(t), . . . , x_{M}(t) that can be represented by the time domain mixed signal vector x(t). Each component of the mixed signal vector xₘ(t) can include a convolutive mixture of audio source signals to be separated, which can include sources of both local origin and distant origin, with the convolutive mixing process cause by reverberant conditions of the environment in which the signals are detected.

If signal processing 200 is to be performed digitally, signal processing 200 can include converting the mixed signals x(t) to digital form with an analog to digital converter (ADC). The analog to digital conversion 203 will utilize a sampling rate sufficiently high to enable processing of the highest frequency component of interest in the underlying source signal. Analog to digital conversion 203 can involve defining a sampling window that defines the length of time segments for signals to be input into the ICA separation process. By way of example, a rolling sampling window can be used to generate a series of time segments to be converted into the time-frequency domain. The sampling window can be chosen according to various application specific requirements, as well as available resources, processing power, etc.

In order to perform frequency domain independent component analysis in conjunction with acoustic echo cancellation according to embodiments of the present invention, a Fourier-related transform 204, preferably STFT, can be performed on the time domain signals to convert them to time-frequency representations for processing by signal processing 200. STFT will load frequency bins 204 for each time segment and mixed signal on which frequency domain ICA will be performed. Loaded frequency bins can correspond to spectrogram representations of each time-frequency domain mixed signal for each time segment.

Although the STFT is referred to herein as an example of a Fourier-related transform, the term “Fourier-related transform” is not so limited. In general, the term “Fourier-related transform” refers to a linear transform of functions related to Fourier analysis. Such transformations map a function to a set of coefficients of basis functions, which are typically sinusoidal and are therefore strongly localized in the frequency spectrum. Examples of Fourier-related transforms applied to continuous arguments include the Laplace transform, the two-sided Laplace transform, the Mellin transform, Fourier transforms including Fourier series and sine and cosine transforms, the short-time Fourier transform (STFT), the fractional Fourier transform, the Hartley transform, the Chirplet transform and the Hankel transform. Examples of Fourier-related transforms applied to discrete arguments include the discrete Fourier transform (DFT), the discrete time Fourier transform (DTFT), the discrete sine transform (DST), the discrete cosine transform (DCT), regressive discrete Fourier series, discrete Chebyshev transforms, the generalized discrete Fourier transform (GDFT), the Z-transform, the modified discrete cosine transform, the discrete Hartley transform, the discretized STFT, the Hadamard transform (or Walsh function), and wavelet analysis or functional analysis that is applied to single dimension time domain speech.

In order to simplify the mathematical operations to be performed in frequency domain ICA, in embodiments of the present invention, signal processing 200 can include preprocessing 205 of the time frequency domain signal X(f, t), which can include well known preprocessing operations such as centering, whitening, etc. Preprocessing can include de-correlating the mixed signals by principal component analysis (PCA) prior to performing the source separation 206, which can be used to improve the convergence speed and stability.

Signal separation by frequency domain ICA in conjunction with AEC 206 can be performed iteratively in conjunction with joint optimization 208, which jointly finds the solution to the multi-channel separation problem and multi-channel acoustic echo problem in the same operation. Combined source separation and acoustic echo cancellation 206 involves setting up a de-mixing matrix operation W that produces maximally independent estimated source signals Y of original source signals S when the de-mixing matrix is applied to mixed signals X corresponding to those received by 202. Combined ICA and AEC 206 also involves, jointly and in the same operation, setting up AEC filters that filter out echoes that may correspond to signals of distant origin. Combined ICA and AEC 206 incorporates a joint optimization process 208 to iteratively update the de-mixing matrix and AEC filters involved processing the mixed signals until the de-mixing matrix converges to a solution that produces maximally independent estimates of source signals sufficiently free of interfering echo signals, to within an acceptable level. Joint optimization 208 incorporates an optimization algorithm or learning rule that defines the iterative process until the de-mixing matrix and AEC filters converge to an acceptable solution. By way of example, combined source separation and acoustic echo cancellation 206 in conjunction with optimization 208 can use an expectation maximization algorithm (EM algorithm) to estimate the parameters of the component probability density functions.

In some implementations, the cost function may be defined using an estimation method, such as Maximum a Posteriori (MAP) or Maximum Likelihood (ML). The solution to the signal separation problem can them be found using a method, such as EM, a Gradient method, and the like. By way of example, and not by way of limitation, the cost function of independence may be defined using ML and optimized using EM.

Once estimates of source signals are produced by separation process (e.g. after convergence), rescaling 216 and optional single channel spectrum domain speech enhancement 210 can be performed to produce accurate time-frequency representations of estimated source signals required due to simplifying pre-processing step 205.

In order to produce estimated sources signals y(t) in the time domain that directly correspond to the original time domain source signals s(t), signal processing 200 can further include performing an inverse Fourier transform 212 (e.g. inverse STFT) on the time-frequency domain estimated source signals Y(f, t) to produce time domain estimated source signals y(t). Estimated time domain source signals can be reproduced or utilized in various applications after digital to analog conversion 214. By way of example, estimated time domain source signals can be reproduced by speakers, headphones, etc. after digital to analog conversion, or can be stored digitally in a non-transitory computer readable medium for other uses. The Fourier transform process 212 and digital to analog conversion process are optional and need not be implemented, e.g., if the spectrum output of the rescaling 216 and optional single channel spectrum domain speech enhancement 210 is converted directly to a speech recognition feature.

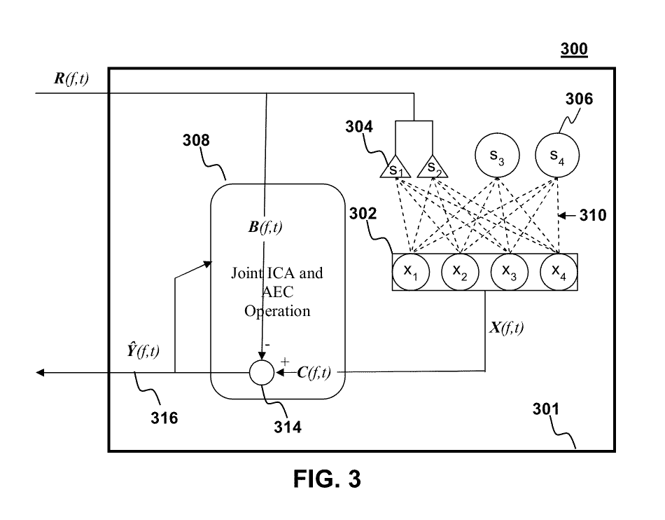

FIG. 3 depicts an example of signal processing in accordance with an embodiment of the present invention that combines acoustic echo cancellation with source separation by independent component analysis. A joint signal processing model 300 produces signals that are the solution to both the source separation and acoustic echo cancellation problem. It is noted that conversion to and from the time domain may be required at various points in the joint model 300, such as when converting to or from microphone or loudspeakers signals for input into frequency domain ICA or AEC operations, but these conversions are not depicted in FIG. 3 for simplicity.

In FIG. 3, a room 301 is depicted which can be considered the near end room for the acoustic echo cancellation. The room 301 may contain walls and other objects which affect the reverberant conditions of the room, thereby affecting the room impulse response of audio signals in the room. Microphone array 302 used to detect source signals s=s₁, s_{z}, s₃, s₄ which mix in the room environment according to a mixing process 310 to produce mixed microphone signals x=x₁, x₂, x₃, x₄. For simplicity, a determined case having only four microphones and four source signals are depicted in FIG. 3, but it is noted that embodiments of the present invention may include any number of sources or microphones and can apply to overdetermined and underdetermined source separation cases. The multiple microphones and multiple loudspeakers (i.e. multi-input and multi-output, or “MIMO”) creates a multichannel source separation and multichannel acoustic echo cancellation problem.

Separate source signals s include both loudspeaker signals 304 and local source signals 306, wherein the loudspeaker signals 304 correspond to far end signals R(f, t) that originate from a different location and are used as reference signals in the AEC filters C(f, t) in a joint ACE and de-mixing operation 308. The local source signals 306 originate from the near end of the room 301, and may be, for example, speech signals originating from persons located in the room 301. The source signals s are mixed in the near end environment according to the unknown mixing process 310, which may include reverberant conditions causing echoes of both the loudspeaker signals 304 and local signals 306 to be detected by the microphone array 302. In this manner, mixed signals x may be convolutive mixtures of the source signals s.

The source separation component of the joint model 300 involves performing independent component analysis by applying ICA demixing operations 312 to the mixed signals X(f, t) obtained from the microphone array 302, wherein the demixing operations can be represented by the matrix W(f, t). The goal of the source separation component is to produce maximally independent signals from the mixtures x observed by the microphone array 402 that correspond to estimates of the source signals s.

Joint model 300 also involves performing acoustic echo cancellation by applying adaptive AEC filters 308 C(f, t) to reference signals R(f, t), wherein the reference signals correspond to the signals played by the loudspeakers 304. The AEC filters C(f,t) can be continuously adapted to the reverberant conditions of the near end room 301 based on data received from microphones 302 in order to accurately model the room impulse response, which may change based on changing conditions in room 301, for example by persons in the room moving around and changing positions. The goal of acoustic echo cancellation is for the AEC filters 308 to create signals that match the echoes of the reference signals present in the microphone signals X(f, t) when the adaptive filters are applied to the reference signals R(f, t). As such, these estimated echo signals can be subtracted from the signals detected by the microphone array to produce clean signals having the interfering acoustic echoes cancelled out.

As indicated by junction 314, joint model 300 can involve both separating local source signals and subtracting the AEC component at the same time implement a de-mixing operation (represented, e.g., by de-mixing matrix B(f,t)) to produce an array processing solution Ŷ(f, t) that corresponds to estimates of the local source signals 306 while the loudspeaker source signals 304 are cancelled out by the AEC component of the joint solution. As can be seen from FIG. 3, the reference signals R(f,t), e.g., as reproduced in loudspeakers 304, can be considered to inherently be a solution to the source separation problem (i.e. de-mixing of the mixing operation 310 may produce estimates for both loudspeaker source signals 304 as well as the local source signals 306).

In order to find an accurate solution to the AEC filters C(f,t) and the demixing matrix B(f,t), optimization functions need to be performed (i.e. refer back to optimization 208 mentioned in FIG. 2) on both the AEC filters and the ICA demixing matrix, in order to produce maximally independent estimates of the source signals with the acoustic echoes cancelled out to within an acceptable error level. Optimization can involve iteratively updating filters C(f, t) and the demixing matrix B(f, t) until both converge to a solution that is within an acceptable level. In embodiments of the present invention, the optimization of the demixing operations and the AEC filters can be performed jointly in the same solution.

Joint optimization can involve maximizing a cost function that defines independence between the solutions Y(f, t) to the joint problem 300. Maximizing the cost function can involve maximization with respect to a measure of non-Gaussianity between the source signals and a Gaussian signal having the same mean and variance as the source signals. The maximization of the cost function involves non-Gaussianity of the sources such that the maximization will produce maximally independent estimates of the sources. Specifically, Negentropy can be used as a measure for independence. In information theory and statistics, the term Negentropy refers to a measure of distance to normality. Out of all distributions with a given variance, the normal or Gaussian distribution is the one with the highest entropy. Negentropy measures the difference in entropy between a given distribution and the Gaussian distribution with the same variance. The ICA used in the source separation can use multivariate probability density functions to preserve the alignments between frequency bins and address the permutation problem described in Equation (3) as the permutation matrix P. By way of example, the cost function can include the KL-Divergence between source signal and Gaussian signal having same mean and variance with source signals as a measure of independence between the solutions Y of the joint source separation and acoustic echo cancellation problem. Equation (29) below is an example of such a cost function.

In embodiments of the present invention, the cost function for independence may be defined in terms of maximizing non-Gaussianity, specifically maximizing Negentropy. Theoretically, this may be viewed as equivalent to minimizing mutual information for obtaining independent sources from mixture. Maximizing non-Gaussianity has advantages when applied to the source extraction problem. Specifically, by maximimizing non-Gaussianity, one can extract a single source even if there are a number of sources and microphones.

### Models

Signal processing 200 utilizing frequency domain ICA in conjunction with AEC 206 and joint optimization 208 as described above can involve appropriate models for the arithmetic operations to be performed by a signal processing device according to embodiments of the present invention. In the following description, firstly, models will be described that utilize multivariate PDFs in frequency domain ICA operations without utilizing mixed multivariate PDFs or AEC. Secondly, models will then be described that utilize mixed multivariate PDFs in the ICA calculation. Models will then be described that incorporate ICA in conjunction with AEC in the same operation using the multivariate PDFs described herein according to embodiments of the present invention. While the models described herein are provided for complete and clear disclosure of embodiments of the present invention, it is noted that persons having ordinary skill in the art can conceive of various alterations of the following models without departing from the scope of the present invention.

### ICA Model Using Multivariate PDFs

In order to perform frequency domain ICA, frequency domain data must be extracted from the time domain mixed signals, and this can be accomplished by performing a Fourier-related transform on the mixed signal data. For example, a short-time Fourier transform (STFT) can convert the time domain signals x(t) into time-frequency domain signals, such that,

Xₘ(f,t)=STFT(xₘ(t)) (4)

and for F number of frequency bins, the spectrum of the m^{th} microphone will be,

Xₘ(t)=[Xₘ(1,t) . . . Xₘ(F,t)] (5)

For M number of microphones, the mixed signal data can be denoted by the vector X(t), such that,

X(t)=[X₁(t) . . . X_{M}(t)]^{T} (6)

In the expression above, each component of the vector corresponds to the spectrum of the m^{th} microphone over all frequency bins 1 through F. Likewise, for the estimated source signals Y(t),

Yₘ(t)=[Yₘ(1,t) . . . Yₘ(F,t)] (1)

Y(t)=[Y₁(t) . . . Y_{M}(t)]^{T} (18)

Accordingly, the goal of ICA can be to set up a matrix operation that produces estimated source signals Y(t) from the mixed signals X(t), where W(t) is the de-mixing matrix. The matrix operation can be expressed as,

Y(t)=W(t)X(t) (9)

Where W(t) can be set up to separate entire spectrograms, such that each element Wᵢⱼ(t) of the matrix W(t) is developed for all frequency bins as follows,

$$\begin{matrix}{W}_{ij} ( t ) = [ \begin{matrix}{W}_{ij} ( 1 , t ) & … & 0 \\ ⋮ & ⋱ & ⋮ \\ 0 & … & {W}_{ij} ( F , t )\end{matrix} ] & ( 10 ) \\ W ( t ) {=}^{Δ} [ \begin{matrix}{W}_{11} ( t ) & … & {W}_{1 M} ( t ) \\ ⋮ & ⋱ & ⋮ \\ {W}_{M 1} ( t ) & … & {W}_{MM} ( t )\end{matrix} ] & ( 11 )\end{matrix}$$

For now, it is assumed that there are the same number of sources as there are microphones (i.e. number of sources=M). Embodiments of the present invention can utilize ICA models for overdetermined or underdetermined cases, where the number of sources is greater than the number of microphones, but for now explanation is limited to the case where the number of sources is equal to the number of microphones for clarity and simplicity of explanation.

The de-mixing matrix W(t) can be solved by a looped process that involves providing an initial estimate for de-mixing matrix W(t) and iteratively updating the de-mixing matrix until it converges to a solution that provides maximally independent estimated source signals Y. The iterative optimization process involves an optimization algorithm or learning rule that defines the iteration to be performed until convergence (i.e. until the de-mixing matrix converges to a solution that produces maximally independent estimated source signals). Optimization can involve a cost function defined to maximize non-Gaussianity for the estimated sources. The cost function can utilize the Kullback-Leibler Divergence as a measure of independence between source signals and a Gaussian signal having same mean and variance as the source signals. Using a spherical distribution as one kind of PDF, the PDF P_{Y}_{ₘ}(Yₘ(t)) of the spectrum of m^{th} source can be expressed as,

$$\begin{matrix}{P}_{{Y}_{m}} ( {Y}_{m} ( t ) ) = h \cdot ψ ( {‖ {Y}_{m} ( t ) ‖}_{2} ) & ( 12 ) \\ ( {‖ {Y}_{m} ( t ) ‖}_{2} ) {=}^{Δ} {( {\sum }_{f} {\vert {Y}_{m} ( f , t ) \vert}^{2} )}^{\frac{1}{2}} & ( 13 )\end{matrix}$$

Where ψ(x)=exp{−Ω|x|}, Ω is a proper constant and h is the normalization factor in the above expression. The final multivariate PDF for the m^{th} source is thus,

$${P}_{{Y}_{m}} ( {Y}_{m} ( t ) ) = h \cdot ψ ( {‖ {Y}_{m} ( t ) ‖}_{2} ) = h exp \{ - Ω {‖ {Y}_{m} ( t ) ‖}_{2} \} = h exp \{ - {Ω ( {Σ}_{f} {\vert {Y}_{m} ( f , t ) \vert}^{2} )}^{\frac{1}{2}} \} \qquad ( 14 )$$

The PDF model described above can be used in implementing the frequency domain ICA in conjunction with AEC 206 of FIG. 2 or the joint ACE and de-mixing operation 308 of FIG. 3 to provide the solution of the permutation problem.

### ICA Model Using Mixed Multivariate PDFs

Having modeled approaches that utilize singular multivariate PDFs in frequency domain ICA, a model using mixed multivariate PDFs will be described.

According to embodiments of the present invention, a speech separation system can utilize independent component analysis involving mixed multivariate probability density functions that are mixtures of L component multivariate probability density functions having different parameters. It is noted that the separate source signals can be expected to have PDFs with the same general form (e.g. separate speech signals can be expected to have PDFs of super-Gaussian form), but the parameters from the different source signals can be expected to be different. Additionally, because the signal from a particular source will change over time, the parameters of the PDF for a signal from the same source can be expected to have different parameters at different time segments. Accordingly, embodiments of the present invention can mixed multivariate PDFs that are mixtures of PDFs weighted for different sources and/or different time segments. Accordingly, embodiments of the present invention can utilize a mixed multivariate PDF that can accounts for the different statistical properties of different source signals as well as the change of statistical properties of a signal over time.

As such, for a mixture of L different component multivariate PDFs, L can generally be understood to be the product of the number of time segments and the number of sources for which the mixed PDF is weighted (e.g. L=number of sources×number of time segments).

Embodiments of the present invention can utilize pre-trained eigenvectors to estimate of the de-mixing matrix. Where V(t) represents pre-trained eigenvectors and E(t) is the eigenvalues, de-mixing can be represented by,

Y(t)=V(t)E(t)=W(t)X(t) (15)

V(t) can be pre-trained eigenvectors of clean speech, music, and noises (i.e. V(t) can be pre-trained for the types of original sources to be separated). Optimization can be performed to find both E(t) and W(t). When it is chosen that V(t)≡I then estimated sources equal the eigenvalues such that Y(t)=E(t).

Optimization according to embodiments of the present invention can involve utilizing an expectation maximization algorithm (EM algorithm) to estimate the parameters of the mixed multivariate PDF for the ICA calculation.

According to embodiments of the present invention, the probability density function P_{Y}_{_{m,l}}(Y_{m,l}(t)) is assumed to be a mixed multivariate PDF that is a mixture of multivariate component PDFs. The mixing system can be represented by,

$$X ( f , t ) = {\sum }_{l = 0}^{L} A ( f , l ) S ( f , t - l ) \qquad ( 16 )$$

Likewise, the de-mixing system can be represented by,

Y(f,t)=Σₗ₌₀^{L}W(f,l)X(f,t−1)=Σₗ₌₀^{L}Y_{m,l}(f,t) (17)

Where A(f, l) is a time dependent mixing condition.

Where spherical distribution is chosen for the PDF, the mixed multivariate PDF becomes,

P_{Y}_{ₘ}(Y_{m,l}(t)) [symbol] Σₗ^{L}bₗ(t)P_{Y}_{_{m,l}}(Yₘ(t)),t∝[t1,t2] (18)

P_{Y}_{ₘ}(Yₘ(t))=Σₗbₗ(t)hₗfₗ(∥Yₘ(t)∥₂),t∝[t1,t2] (19)

In the above expressions, t1 refers to the beginning time for processing a signal segment (e.g., a speech segment) and t2 refers to the ending time of processing the segment.

Where multivariate generalized Gaussian is chosen for the PDF, the mixed multivariate PDF becomes,

P_{Y}_{_{m,l}}(Y_{m,l}(t)) [symbol] Σₗ^{L}bₗ(t)hₗΣ_{c}ρ(cₗ(m,t))Π_{f}N_{c}(Yₘ(f,t)|0,v_{Y}_{ₘ}_{(f,t)}^{f})),t∝[t1,t2] (20a)

Where ρ(c) is the weight between different c^{th} component multivariate generalized Gaussian and bₗ(t) is the weight between different time segments. N_{c}(Yₘ(f, t)|0, v_{Y}_{ₘ}_{(f,t)}^{f}) can be pre-trained with offline data, and further trained with run-time data.

The PDF model described above can be used to provide the solution of the permutation problem.

In some embodiments, the de-mixing matrix W may be solved iteratively with pre-trained Eigen-vectors. Specifically, the estimated source signals may be written as (t)=V(t)E(t)=W(t)X(t), where V(t) can be pre-trained eigen-vectors of clean signals, e.g., speech, music, or other sounds and E(t) represents the eigenvalues.→

$$\{ \begin{matrix}V ( t ) É ( t ) = Y ( t ) = {W}^{′} ( t ) X ( t ) , t = [ {t}_{1} , {t}_{2} ] \to data set 1 \\ V ( t ) E ( t ) = Y ( t ) = W ( t ) X ( t ) , t = [ {t}_{3} , {t}_{4} ] \to data set 2\end{matrix}$$

where the eigenvectors V(t) are pre-trained.

The dimension of E(t) or É(t) can be smaller than the dimension of X(t)

The optimization is to find {V(t), E(t), W(t)}. Data set 1 generally includes training data or calibration data. Data set 2 generally includes testing data or real time data. If one chooses (t)≡I, then Y(t)=E(t), the formula falls back into normal case of single equation.
a) When data set 1 is of mono-channel clean training data, Y(t) is known, W(t)=I, X(t)=Y(t). The optimal solution V(t) is the Eigen vectors of Y(t).
b) Given data set 1 and data set 2, the task is to find best {E(t), W(t)} given microphone array data X(t), and known Eigen vectors V(t). That is to solve the following equation

V(t)E(t)=W(t)X(t)

If V(t) is a square matrix,

E(t)=V(t)⁻¹W(t)X(t)

If V(t) is not a square matrix,

E(t)=(V(t)^{T}V(t))⁻¹V(t)^{T}W(t)X(t)

or

E(t)=V(t)^{T}(V(t)^{T}V(t))⁻¹W(t)X(t)

P_{E}_{_{m,l}}(E_{m,l}(t)) is assumed to be a mixture of multivariate PDF for microphone ‘m’ and PDF mix mixture component ‘l’.

### b) New Demixing System

E(f,t)=V⁻¹(f,t)W(f)X(f,t)

E(f,t)=Σₗ₌₀^{L}V⁻¹(f,t)W(f,l)X(f,t−l)=Σₗ₌₀^{L}E_{m,l}(f,t) (20b)

Note that a model for underdetermined cases (i.e. where the number of sources is greater than the number of microphones) can be derived from expressions (16) through (20b) above and are within the scope of the present invention.

The ICA model used in embodiments of the present invention can utilize the cepstrum of each mixed signal, where Xₘ(f, t) can be the cepstrum of xₘ(t) plus the log value (or normal value) of pitch, as follows,

Xₘ(f,t)=STFT(log(∥xₘ(t)∥²)),f=1,2, . . . ,F−1 (21)

Xₘ(F,t) [symbol] log(f₀(t)) (22)

Xₘ(t)=[Xₘ(1,t) . . . X_{F-1}(F−1,t)X_{F}(F,t)] (23)

It is noted that a cepstrum of a time domain speech signal may be defined as the Fourier transform of the log (with unwrapped phase) of the Fourier transform of the time domain signal. The cepstrum of a time domain signal S(t) may be represented mathematically as FT(log(FT(S(t)))+j2πq), where q is the integer required to properly unwrap the angle or imaginary part of the complex log function. Algorithmically, the cepstrum may be generated by performing a Fourier transform on a signal, taking a logarithm of the resulting transform, unwrapping the phase of the transform, and taking a Fourier transform of the transform. This sequence of operations may be expressed as: signal→FT→log→phase unwrapping→FT→cepstrum.

In order to produce estimated source signals in the time domain, after finding the solution for Y(t), pitch+cepstrum simply needs to be converted to a spectrum, and from a spectrum to the time domain in order to produce the estimated source signals in the time domain. The rest of the optimization remains the same as discussed above.

Different forms of PDFs can be chosen depending on various application specific requirements for the models used in source separation according to embodiments of the present invention. By way of example, the form of PDF chosen can be spherical. More specifically, the form can be super-Gaussian, Laplacian, or Gaussian, depending on various application specific requirements. It is noted that each mixed multivariate PDF is a mixture of component PDFs, and each component PDF in the mixture can have the same form but different parameters.

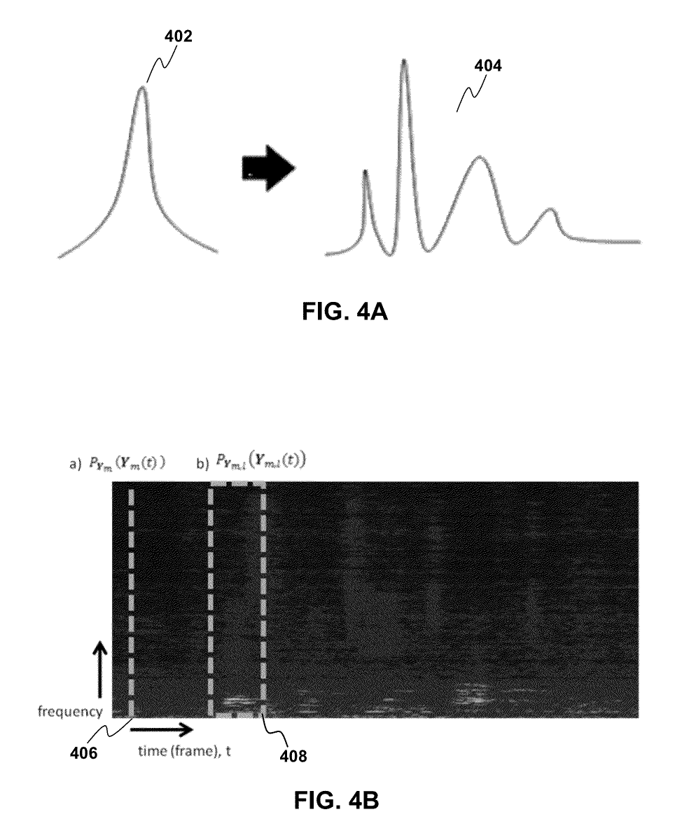

FIGS. 4A-4B demonstrate the difference between singular PDFs and mixed multivariate PDFs according as described herein. A mixed multivariate PDF may result in a probability density function having a plurality of modes corresponding to each component PDF as shown in FIG. 4A. In the singular PDF 402 in FIG. 4A, the probability density as a function of a given variable is uni-modal, i.e., a graph of the PDF 402 with respect to a given variable has only one peak. In the mixed PDF 404 the probability density as a function of a given variable is multi-modal, i.e., the graph of the mixed PDF 404 with respect to a given variable has more than one peak. It is noted that FIG. 4A is provided as a demonstration of the difference between a singular PDF 402 and a mixed PDF 404. Note, however, that the PDFs depicted in FIG. 4A are univariate PDFs and are merely provided to demonstrate the difference between a singular PDF and a mixed PDF. In mixed multivariate PDFs there would be more than one variable and the PDF would be multi-modal with respect to one or more of those variables. In other words, there could be more than one peak in a graph of the PDF with respect to at least one of the variables.

Referring to FIG. 4B, a spectrogram is depicted to demonstrating the difference between a singular multivariate PDF and a mixed multivariate PDF, and how a mixed multivariate PDF can be weighted for different time segments. Singular multivariate PDF corresponding to time segment 406 as shown by dotted line can correspond to P_{Y}_{ₘ}(Yₘ(t)) as described above. By contrast, mixed multivariate PDF corresponding to time frame 308 can cover a time frame that spans multiple different time segments, as shown by the dotted rectangle in FIG. 4B. A mixed multivariate PDF can correspond to P_{Y}_{_{m,l}}(Y_{m,l}(t)) as described above.

Combined Source Separation by Independent Component Analysis with Acoustic Echo Cancellation

Having described source separation techniques that use multivariate PDFs to preserve the alignment between frequency bins, signal processing models that combine independent component analysis with acoustic echo cancellation will be described.

### Traditional AEC

In a traditional multichannel AEC model, filters C(f) are applied to reference signals R(f, t), and those are removed from microphone signals X(f, t), such that the solution to the multichannel AEC are signals Y(f, t) as follows,

Y(f,t)=X(f,t)−C(f)R(f,t)

where

$$X ( f , t ) = {[ {X}_{1} ( f , t ) … {X}_{M} ( f , t ) ]}^{T} , \\ R ( f , t ) = {[ {R}_{1} ( f , t ) … {R}_{L} ( f , t ) ]}^{T} and$$

$$C ( f ) = {[ \begin{matrix}{C}_{11} ( f ) & … & {C}_{1 M} ( f ) \\ ⋮ & ⋱ & ⋮ \\ {C}_{L 1} ( f ) & … & {C}_{LM} ( f )\end{matrix} ]}^{T}$$

Referring again to the example of microphone array source separation in conjunction with acoustic echo cancellation, M is the number of microphones and L is the number of echo signals (i.e., the number of reference signals)

Most AEC techniques solve for the AEC filters by setting up a cost function that uses least mean square (LMS) criterion for the adaptive filters, where the traditional AEC cost function J_{LMS} can be represented as,

J_{LMS=}E(∥Y(f,t)∥²)

Where E( ) is the expectation. Note that in a traditional AEC model, the acoustic echoes are removed directly from the microphone signals independent of any source separation.

Combined Independent Component Analysis with Acoustic Echo Cancellation

In embodiments of the present invention, acoustic echo cancellation can be combined with source separation by independent component analysis to produce separated source signals without interfering echoes. The AEC filters (C(f)) and ICA de-mixing matrix (B(f)) can be jointly optimized until both convergence of filters that produce clean echo free signals within an acceptable error tolerance and convergence of demixing operations that produces maximally independent sources. Accordingly, joint optimization can find the solution to a multichannel acoustic echo cancellation and multichannel source separation problem in the same solution. The joint model that includes both source separation and acoustic echo cancellation of the microphone signals can be set up as follows,

Ŷ(f,t)=B(f)X(f,t)−C(f)R(f,t) (24)

where
X(f,t)=[X₁(f,t) . . . X_{M}(f,t)]^{T},
R(f,t)=[R₁(f,t) . . . R_{L}(f,t)]^{T}
   and

$$C ( f ) = {[ \begin{matrix}{C}_{11} ( f ) & … & {C}_{1 M} ( f ) \\ ⋮ & ⋱ & ⋮ \\ {C}_{L 1} ( f ) & … & {C}_{LM} ( f )\end{matrix} ]}^{T} , \\ B ( f ) = {[ \begin{matrix}{B}_{11} ( f ) & … & {B}_{1 M} ( f ) \\ ⋮ & ⋱ & ⋮ \\ {B}_{M 1} ( f ) & … & {B}_{MM} ( f )\end{matrix} ]}^{T}$$

Again, in the example of microphone array source separation in conjunction with acoustic echo cancellation M is the number of microphones and L is the number of echo signals (number of reference signals).

Turning again to FIG. 3, it can be seen that equation (24) corresponds to the operation at junction 314 that produces Ŷ(f,t).

In equation (24) Ŷ(f, t) is a solution that removes signals matching the reference signals from the solution to the source separation problem and separates local source signals at the same time. Note that the reference signals may correspond to source signals that are desired as part of the solution to the source separation problem (e.g. where loudspeaker reproductions of the reference signals mix with local signals as described with respect to FIG. 3 above). To the extent that the reference signals are sources that are desired solutions to the source separation problem, those sources are inherently cancelled out by the AEC component of the above expression. Accordingly, a matrix operation can be set up to find the solution to the multi-channel separation and multi-channel AEC problem jointly that includes the reference signals as part of the source separation solution as follows,

$$\hat{Y} ( f , t ) = B ( f ) X ( f , t ) - C ( f ) R ( f , t ) \\ Y ( f , t ) = [ \begin{matrix}\hat{Y} ( f , t ) \\ R ( f , t )\end{matrix} ] = [ \begin{matrix}B ( f ) & - C ( f ) \\ 0 & I\end{matrix} ] [ \begin{matrix}X ( f , t ) \\ R ( f , t )\end{matrix} ] = [ \begin{matrix}{W}_{11} ( f ) & {W}_{12} ( f ) \\ {W}_{21} ( f ) & {W}_{22} ( f )\end{matrix} ] [ \begin{matrix}X ( f , t ) \\ R ( f , t )\end{matrix} ] \qquad ( 25 )$$

In equation (25) I is the identity matrix and 0 is the zero matrix.

A new cost function using maximization of Negentropy for independence criterion can be set up as follows,

N(Y(t))=KLD(P_{Y(t)}(Y(t))∥P_{Y}_{_{gauss}}(Y_{gauss})) (26)

In equation (26), the expression N(Y(t)) is referred to as the Negentropy. Theoretically, the independence criterion is equivalent to either minimization of mutual information or maximization of Negentropy.

In equation (26) Y_{gauss} refers to a Gaussian distributed source signal having the same variance as Y(f,t).

The cost function of equation (26) is subject to the constraint that Y(f, t) has been normalized for unit variance, i.e.

E{(Y(f,t))^{H}Y(f,t)}=W(f)^{H}W(f)=1 (27)

The Negentropy can be arranged as follows by using the entropy function, H(X), which is defined by

H(X)=−∫P_{X}(X)log P_{X}(X)dX (28)

where X=[X (1, t), . . . , X (F, t)]^{T} and P_{X}(X) is a probability density function, which can be a multivariate PDF or a mixed multivariate PDF.

From (26) and (28), the cost function can be rewritten as follows when using multivariate PDF.

N(Y(t))=KLD(P_{Y(t)}(Y(t))∥P_{Y}_{_{gauss}}(Y_{gauss}))=H(Y_{gauss})−H(Y(t)) (29)

Because cost function in equation (29) is subject to the constraint that Y(f, t) has been normalized for unit variance from equation (27), H(Y_{gauss}) is a constant. By applying equation (14) into (28) and (29), we have the equation as follows

N(Y(t))≅−H(Y(t))=−E(log P_{Y(t)}(Y(t))=E(G(Σ_{f}|Y(f,t)|²)) (30)

In equation (30), the expression E( ) refers to the expectation value of the quantity in parentheses and the expression G( ) refers to the square root function when using P_{Y(t)}(Y(t)) as equation (14). By way of example, and not by way of limitation, P_{Y(t)}(Y(t)) may be used any of the techniques described in U.S. Pat. No. 7,797,153 (which is incorporated herein by reference) at col. 13, line 3 to col. 13, line 45.

We can derive the learning rule based on gradient ascent as follows:

$$\begin{matrix} \frac{\partial N ( Y ( t ) )}{\partial {W}_{11} ( f )} = E ( {( Y ( f , t ) )}^{*} g ( {Σ}_{f} {\vert Y ( f , t ) \vert}^{2} ) {X}_{1} ( f , t ) ) & ( 31 ) \\ \frac{\partial N ( Y ( t ) )}{\partial {W}_{12} ( f )} = E ( {( Y ( f , t ) )}^{*} g ( {Σ}_{f} {\vert Y ( f , t ) \vert}^{2} ) {X}_{2} ( f , t ) ) - E ( {( Y ( f , t ) )}^{*} g ( {Σ}_{f} {\vert Y ( f , t ) \vert}^{2} ) R ( f , t ) ) & ( 32 )\end{matrix}$$

where g is the 1^{st} derivative of G with respect to W₁₁(f) and W₁₂ (f), and * is the conjugate operation.

The final update rules can be expressed as follows:

$$[ \begin{matrix}{W}_{11} ( f ) & {W}_{12} ( f )\end{matrix} ] = [ \begin{matrix}{W}_{11} ( f ) & {W}_{12} ( f )\end{matrix} ] + η [ \frac{\partial N ( Y ( t ) )}{\partial {W}_{11} ( f )} \frac{\partial N ( Y ( t ) )}{\partial {W}_{12} ( f )} ] \qquad ( 33 )$$

where η is the learning rate.

In the final update, it is not necessary to calculate the gradient of W₂₁(f) and W₂₂(f) because they correspond to reference signals.

For every iteration, B(f) is rescaled using equation (42), (43), (44), a discussed below.

For every iteration, the filters should be normalized to satisfy the following condition E{(Y(f, t))^{H}Y(f, t)}=W(f)^{H}W(f)=1 using one of the following two orthogonalization methods depending on the nature of the source separation problem.

When it is desired to separate every source, symmetric orthogonalization could be used to normalize the filters, e.g., as indicated by equation (34) below.

$$W ( f ) ← {( W ( f ) {W ( f )}^{H} )}^{- \frac{1}{2}} W ( f ) \qquad ( 34 )$$

When extraction of sources one by one is desired, deflationary orthogonalization could be used to normalize the filters, e.g., as indicated by equation (35) below.

Wᵢ(f)←Wᵢ(f)−Σⱼ₌₁^{M-1}(Wᵢ(f)^{H}Wⱼ(f))Wⱼ(f) (35)

For example, if there are several source signals but there is one desired source, the desired source can be extracted using the deflationary orthogonalization without having to extract the other source signals. As a result, the computational complexity of the source signal extraction may be reduced. The decision to choose which normalization method can be purely application choice, or one could use video input to decide whether there is only one major speaker in front of the monitor.

It is noted that the foregoing derivation of the learning rule can be extended to implementations that use mixed multivariate PDF.

Accordingly, the solution to the joint model can involve minimizing a cost function using independence criterion, where the cost function includes acoustic echo cancellation as described above. Note that the probability density function P_{Y}_{ₘ} (Yₘ(t)) can involve either singular multivariate PDFs or the mixed multivariate PDFs described above.

### Rescaling Process & Optional Single Channel Spectrum Domain Speech (FIG. 2, 216)

The rescaling process indicated at 216 of FIG. 2 adjusts the scaling matrix D, which is described in equation (3), among the frequency bins of the spectrograms. Furthermore, rescaling process 216 cancels the effect of the pre-processing.

By way of example, and not by way of limitation, the rescaling process indicated at 216 in may be implemented using any of the techniques described in U.S. Pat. No. 7,797,153 (which is incorporated herein by reference) at col. 18, line 31 to col. 19, line 67, which are briefly discussed below.

According to a first technique each of the estimated source signals Yₖ(f,t) may be re-scaled by producing a signal having the single Input Multiple Output from the estimated source signals Yₖ(f,t) (whose scales are not uniform). This type of re-scaling may be accomplished by operating on the estimated source signals with an inverse of a product of the de-mixing matrix W(f) and a pre-processing matrix Q(f) to produce scaled outputs X_{yk}(f,t) given by:

$${X}_{yk} ( f , t ) = {( W ( f ) Q ( f ) )}^{- 1} [ \begin{matrix}0 \\ ⋮ \\ {Y}_{k} ( f , t ) \\ ⋮ \\ 0\end{matrix} ] \qquad ( 42 )$$

where X_{yk} (f, t) represents a signal at y^{th} output from k^{th} source. Q(f) represents a pre-processing matrix, which may be implanted as part of the pre-processing indicated at 205 of FIG. 2 The pre-processing matrix Q(f) may be configured to make mixed input signals X(f,t) have zero mean and unit variance at each frequency bin.

Q(f) can be any function to give the decorrelated output. By way of example, and not by way of limitation, one can use a decorrelation process, e.g., as shown in equations below.

The pre-processing matrix Q(f) can be calculated as follows:

R(f)=E(X(f,t)X(f,t)^{H}) (43)

R(f)qₙ(f)=λₙ(f)qₙ(f) (44)

where qₙ(f) are the eigen vectors and λₙ(f) are the eigen values.

Q′(f)=[q₁(f) . . . qₙ(f)] (45)

Q(f)=diag(λ₁(f)^{-1/2}, . . . ,λ_{N}(f)^{-1/2})Q′(f)^{H} (46)

In a second re-scaling technique, based on the minimum distortion principle, the de-mixing matrix W(f) may be recalculated according to:

W(f)←diag(W(f)Q(f)⁻¹)W(f)Q(f) (47)

In equation (47), Q(f) again represents the pre-processing matrix used to pre-process the input signals X(f,t) at 205 of FIG. 2 such that they have zero mean and unit variance at each frequency bin. Q(f)⁻¹ represents the inverse of the pre-processing matrix Q(f). The recalculated de-mixing matrix W(f) may then be applied to the original input signals X(f,t) to produce re-scaled estimated source signals Yₖ(f,t).

A third technique utilizes independency of an estimated source signal Yₖ(f,t) and a residual signal. A re-scaled estimated source signal may be obtained by multiplying the source signal Yₖ(f,t) by a suitable scaling coefficient αₖ(f) for the k^{th} source and f^{th} frequency bin. The residual signal is the difference between the original mixed signal Xₖ(f,t) and the re-scaled source signal. If αₖ(f) has the correct value, the factor Yₖ(f,t) disappears completely from the residual and the product αₖ(f)·Yₖ(f,t) represents the original observed signal. The scaling coefficient may be obtained by solving the following equation:

E[f(Xₖ(f,t)−αₖ(f)Yₖ(f,t) g̅(̅Y̅ₖ̅(̅f̅,̅t̅)̅)̅]−E[f(Xₖ(f,t)−αₖ(f)Yₖ(f,t)]E[ g̅(̅Y̅ₖ̅(̅f̅,̅t̅)̅)̅]=0 (48)

In equation (48), the functions f(•) and g(•) are arbitrary scalar functions. The overlying line represents a conjugate complex operation and E[ ] represents computation of the expectation value of the expression inside the square brackets. As a result, the scaled output can be calculated by Yₖ^{new}(f,t)=áₖ(f)Yₖ(f,t)

### Signal Processing Device Description

In order to perform source separation according to embodiments of the present invention as described above, a signal processing device may be configured to perform the arithmetic operations required to implement embodiments of the present invention. The signal processing device can be any of a wide variety of communications devices. For example, a signal processing device according to embodiments of the present invention can be a computer, personal computer, laptop, handheld electronic device, cell phone, videogame console, etc.

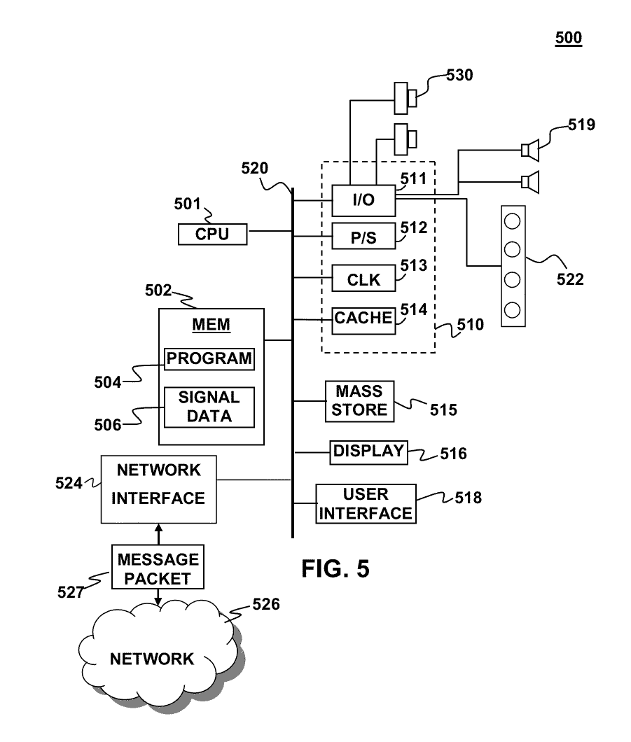

Referring to FIG. 5, an example of a signal processing device 500 capable of performing source separation according to embodiments of the present invention is depicted. The apparatus 500 may include a processor 501 and a memory 502 (e.g., RAM, DRAM, ROM, and the like). In addition, the signal processing apparatus 500 may have multiple processors 501 if parallel processing is to be implemented. Furthermore, signal processing apparatus 500 may utilize a multi-core processor, for example a dual-core processor, quad-core processor, or other multi-core processor. The memory 502 includes data and code configured to perform source separation as described above. Specifically, the memory 502 may include signal data 506 which may include a digital representation of the input signals x (after analog to digital conversion as shown in FIG. 2), and code for implementing source separation using mixed multivariate PDFs as described above to estimate source signals contained in the digital representations of mixed signals x.

The apparatus 500 may also include well-known support functions 510, such as input/output (I/O) elements 511, power supplies (P/S) 512, a clock (CLK) 513 and cache 514. The apparatus 500 may include a mass storage device 515 such as a disk drive, CD-ROM drive, tape drive, or the like to store programs and/or data. The apparatus 500 may also include a display unit 516 and user interface unit 518 to facilitate interaction between the apparatus 500 and a user. The display unit 516 may be in the form of a cathode ray tube (CRT) or flat panel screen that displays text, numerals, graphical symbols or images. The user interface 518 may include a keyboard, mouse, joystick, light pen or other device. In addition, the user interface 518 may include a microphone, video camera or other signal transducing device to provide for direct capture of a signal to be analyzed. The processor 501, memory 502 and other components of the system 500 may exchange signals (e.g., code instructions and data) with each other via a system bus 520 as shown in FIG. 5.

A microphone array 522 may be coupled to the apparatus 500 through the I/O functions 511. The microphone array may include 2 or more microphones. The microphone array may preferably include at least as many microphones as there are original sources to be separated; however, microphone array may include fewer or more microphones than the number of sources for underdetermined cases as noted above. Each microphone the microphone array 522 may include an acoustic transducer that converts acoustic signals into electrical signals. The apparatus 500 may be configured to convert analog electrical signals from the microphones into the digital signal data 506.

The apparatus 500 may include a network interface 524 to facilitate communication via an electronic communications network 526. The network interface 524 may be configured to implement wired or wireless communication over local area networks and wide area networks such as the Internet. The apparatus 500 may send and receive data and/or requests for files via one or more message packets 527 over the network 526. The microphone array 522 may also be connected to a peripheral such as a game controller instead of being directly coupled via the I/O elements 511. The peripherals may send the array data by wired or wired less method to the processor 501. The array processing can also be done in the peripherals and send the processed clean speech or speech feature to the processor 501.

It is further noted that in some implementations, one or more sound sources 519 may be coupled to the apparatus 500, e.g., via the I/O elements or a peripheral, such as a game controller. In addition, one or more image capture devices 530 may be coupled to the apparatus 500, e.g., via the I/O elements or a peripheral such as a game controller.

As used herein, the term I/O generally refers to any program, operation or device that transfers data to or from the system 500 and to or from a peripheral device. Every data transfer may be regarded as an output from one device and an input into another. Peripheral devices include input-only devices, such as keyboards and mouses, output-only devices, such as printers as well as devices such as a writable CD-ROM that can act as both an input and an output device. The term “peripheral device” includes external devices, such as a mouse, keyboard, printer, monitor, microphone, game controller, camera, external Zip drive or scanner as well as internal devices, such as a CD-ROM drive, CD-R drive or internal modem or other peripheral such as a flash memory reader/writer, hard drive.

The processor 501 may perform digital signal processing on signal data 506 as described above in response to the data 506 and program code instructions of a program 504 stored and retrieved by the memory 502 and executed by the processor module 501. Code portions of the program 504 may conform to any one of a number of different programming languages such as Assembly, C++, JAVA or a number of other languages. The processor module 501 forms a general-purpose computer that becomes a specific purpose computer when executing programs such as the program code 504. Although the program code 504 is described herein as being implemented in software and executed upon a general purpose computer, those skilled in the art may realize that the method of task management could alternatively be implemented using hardware such as an application specific integrated circuit (ASIC) or other hardware circuitry. As such, embodiments of the invention may be implemented, in whole or in part, in software, hardware or some combination of both.

An embodiment of the present invention may include program code 504 having a set of processor readable instructions that implement source separation methods as described above. The program code 504 may generally include instructions that direct the processor to perform source separation on a plurality of time domain mixed signals, where the mixed signals include mixtures of original source signals to be extracted by the source separation methods described herein. The instructions may direct the signal processing device 500 to perform a Fourier-related transform (e.g. STFT) on a plurality of time domain mixed signals to generate time-frequency domain mixed signals corresponding to the time domain mixed signals and thereby load frequency bins. The instructions may direct the signal processing device to perform independent component analysis as described above on the time-frequency domain mixed signals to generate estimated source signals corresponding to the original source signals. The independent component analysis will utilize mixed multivariate probability density functions that are weighted mixtures of component probability density functions of frequency bins corresponding to different source signals and/or different time segments.

It is noted that the methods of source separation described herein generally apply to estimating multiple source signals from mixed signals that are received by a signal processing device. It may be, however, that in a particular application the only source signal of interest is a single source signal, such as a single speech signal mixed with other source signals that are noises. By way of example, a source signal estimated by audio signal processing embodiments of the present invention may be a speech signal, a music signal, or noise. As such, embodiments of the present invention can utilize ICA as described above in order to estimate at least one source signal from a mixture of a plurality of original source signals.

Although the detailed description herein contains many specific details for the purposes of illustration, anyone of ordinary skill in the art will appreciate that many variations and alterations to the details described herein are within the scope of the invention. Accordingly, the exemplary embodiments of the invention described herein are set forth without any loss of generality to, and without imposing limitations upon, the claimed invention.

While the above is a complete description of the preferred embodiments of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “a”, or “an” when used in claims containing an open-ended transitional phrase, such as “comprising,” refers to a quantity of one or more of the item following the article, except where expressly stated otherwise. Furthermore, the later use of the word “said” or “the” to refer back to the same claim term does not change this meaning, but simply re-invokes that non-singular meaning. The appended claims are not to be interpreted as including means-plus-function limitations or step-plus-function limitations, unless such a limitation is explicitly recited in a given claim using the phrase “means for” or “step for.”

What is claimed is:

1. A method of processing signals with a signal processing device, comprising:
receiving a plurality of time domain mixed signals in a signal processing device, each time domain mixed signal including a mixture of original source signals;
converting the time domain mixed signals into the time-frequency domain, thereby generating time-frequency domain mixed signals corresponding to the time domain mixed signals; and
performing independent component analysis in conjunction with acoustic echo cancellation on the time-frequency domain mixed signals to generate at least one estimated source signal corresponding to at least one of the original source signals,
wherein said performing independent component analysis in conjunction with acoustic echo cancellation comprises jointly optimizing solutions to an acoustic echo cancellation filter and an independent component analysis de-mixing matrix at the same time, and
wherein the independent component analysis uses a multivariate probability density function to preserve alignment of frequency bins in the at least one estimated source signal.

2. The method of claim 1, wherein the mixture of original source signals includes a far end source signal cancelled by the acoustic echo cancellation and a local source signal.

3. The method of claim 1, wherein the mixed signals include at least one speech source signal, and the at least one estimated source signal corresponds to said at least one speech signal.

4. The method of claim 1, wherein the multivariate probability density function is a mixed multivariate probability density function that is a weighted mixture of component multivariate probability density functions of frequency bins corresponding to different source signals and/or different time segments.

5. The method of claim 1, wherein said performing independent component analysis in conjunction with acoustic echo cancellation comprises minimizing a cost function configured to maximize Negentropy of the estimated source signals.

6. The method of claim 1, wherein said performing a Fourier-related transform comprises performing a short time Fourier transform (STFT) over a plurality of discrete time segments.

7. The method of claim 1, wherein said performing independent component analysis in conjunction with acoustic echo cancellation comprises utilizing an expectation maximization algorithm to estimate the parameters of the component multivariate probability density functions.

8. The method of claim 1, wherein said performing independent component analysis comprises utilizing pre-trained eigenvectors of clean speech in an estimation of the parameters of the component probability density function.

9. The method of claim 8, wherein said performing independent component analysis further comprises utilizing pre-trained eigenvectors.

10. The method of claim 8, wherein said performing independent component analysis further comprises training eigenvectors with run-time data.

11. The method of claim 1, wherein jointly optimizing solutions to an acoustic echo cancellation filter and an independent component analysis de-mixing matrix includes normalizing filters using symmetric orthogonalization.

12. The method of claim 1, wherein jointly optimizing solutions to an acoustic echo cancellation filter and an independent component analysis de-mixing matrix includes normalizing filters using deflationary orthogonalization to extract one of the source signals without having to extract the others.

13. The method of claim 1, wherein the probability density function has a spherical distribution.

14. The method of claim 13, wherein the probability density function has a Laplacian distribution.

15. The method of claim 13, wherein the probability density function has a super-Gaussian distribution.

16. The method of claim 1, wherein the probability density function has a multivariate generalized Gaussian distribution.

17. The method of claim 1, wherein said mixed multivariate probability density function is a weighted mixture of component probability density functions of frequency bins corresponding to different sources.

18. The method of claim 1, wherein said mixed multivariate probability density function is a weighted mixture of component probability density functions of frequency bins corresponding to different time segments.

19. The method of claim 1, further comprising observing the time domain mixed signals with the microphone array before said receiving the time domain mixed signals in a signal processing device.

20. A signal processing device comprising:
a processor;
a memory; and
computer coded instructions embodied in the memory and executable by the processor, wherein the instructions are configured to implement a method of signal processing comprising:
receiving a plurality of time domain mixed signals, each time domain mixed signal including a mixture of original source signals;
converting the time domain mixed signals into the time frequency domain, thereby generating time-frequency domain mixed signals corresponding to the time domain mixed signals; and
performing independent component analysis in conjunction with acoustic echo cancellation on the time-frequency domain mixed signals to generate at least one estimated source signal corresponding to at least one of the original source signals,
wherein said performing independent component analysis in conjunction with acoustic echo cancellation comprises jointly optimizing solutions to an acoustic echo cancellation filter and an independent component analysis de-mixing matrix at the same time, and
the independent component analysis uses a multivariate probability density function to preserve alignment of frequency bins in the at least one estimated source signal.

21. The device of claim 20, further comprising a microphone array for detecting the time domain mixed signals.

22. The device of claim 20, wherein the processor is a multi-core processor.

23. The device of claim 20, wherein the mixed signals include at least one speech source signal, and the at least one estimated source signal corresponds to said at least one speech signal.

24. The device of claim 20, wherein the multivariate probability density function is a mixed multivariate probability density function that is a weighted mixture of component multivariate probability density functions of frequency bins corresponding to different source signals and/or different time segments.

25. The device of claim 24, wherein said performing independent component analysis in conjunction with acoustic echo cancellation comprises utilizing an expectation maximization algorithm to estimate the parameters of the component multivariate probability density functions.

26. The device of claim 24, wherein said mixed multivariate probability density function is a weighted mixture of component probability density functions of frequency bins corresponding to different sources.

27. The device of claim 24, wherein said mixed multivariate probability density function is a weighted mixture of component probability density functions of frequency bins corresponding to different time segments.

28. The device of claim 20, wherein said performing independent component analysis in conjunction with acoustic echo cancellation comprises minimizing a cost function configured to maximize Negentropy of the estimated source signals.

29. The device of claim 20, wherein said performing a Fourier-related transform comprises performing a short time Fourier transform (STFT) over a plurality of discrete time segments.

30. The device of claim 20, wherein said performing independent component analysis comprises utilizing pre-trained eigenvectors of clean speech in an estimation of the parameters of the component probability density functions.

31. The device of claim 30, wherein said performing independent component analysis further comprises utilizing pre-trained eigenvectors of.

32. The device of claim 30, wherein said performing independent component analysis further comprises training eigenvectors with run-time data.

33. The device of claim 20, wherein jointly optimizing solutions to an acoustic echo cancellation filter and an independent component analysis de-mixing matrix includes normalizing filters using symmetric orthogonalization.

34. The device of claim 20, wherein jointly optimizing solutions to an acoustic echo cancellation filter and an independent component analysis de-mixing matrix includes normalizing filters using deflationary orthogonalization to extract one of the source signals without having to extract the others.

35. The device of claim 20, wherein the probability density function has a spherical distribution.

36. The device of claim 35, wherein the probability density function has a Laplacian distribution.

37. The device of claim 35, wherein the probability density function has a super-Gaussian distribution.

38. The device of claim 20, wherein the probability density function has a multivariate generalized Gaussian distribution.

39. A computer program product comprising a non-transitory computer-readable medium having computer-readable program code embodied in the medium, the program code operable to perform signal processing operations comprising:
receiving a plurality of time domain mixed signals, each time domain mixed signal including a mixture of original source signals;
converting the time domain mixed signals into the time-frequency domain, thereby generating time-frequency domain mixed signals corresponding to the time domain mixed signals; and
performing independent component analysis in conjunction with acoustic echo cancellation on the time-frequency domain mixed signals to generate at least one estimated source signal corresponding to at least one of the original source signals,
wherein said performing independent component analysis in conjunction with acoustic echo cancellation comprises jointly optimizing solutions to an acoustic echo cancellation filter and an independent component analysis de-mixing matrix at the same time, and
the independent component analysis uses a multivariate probability density function to preserve alignment of frequency bins in the at least one estimated source signal.
